(19) United States
(12) Patent Application Publication
(10) Pub. No.: US 2026/0058079 A1
(43) Pub. Date: Feb. 26, 2026

(54) Vacuum Monitored Disconnect Switch

(71) Applicant: Southern States, LLC., Hampton, GA (US)

(72) Inventor: Lawrence B Beagen, Fayetteville, GA (US)

(21) Appl. No.: 19/305,984

(22) Filed: Aug. 21, 2025

Related U.S. Application Data
(60) Provisional application No. 63/686,433, filed on Aug. 23, 2024.

(51) Int. Cl. H01H 33/668; H01H 9/08; H01H 9/16; H01H 33/662

(52) U.S. Cl. CPC H01H 33/668; H01H 9/08; H01H 9/167; H01H 33/66261; H01H 2033/66269

(57) ABSTRACT

A vacuum monitored disconnect switch includes vacuum interrupter with a high-voltage electric contactor inside a vacuum bottle, which can fail causing the vacuum switch to electrically short potentially causing extensive damage to the switch and other components. A vacuum monitor in fluid communication with the vacuum bottle includes a capacitance manometer for detecting a vacuum failure of the vacuum bottle. The capacitance manometer and associated components are powered by a current transformer (CT) that harvests power from the power line controlled by the vacuum disconnect switch. A porcelain tube in fluid communication with the interrupter vacuum bottle provides high voltage isolation between the vacuum interrupter bottle and the capacitance manometer to protect the manometer and associated electronics.

### REFERENCE TO RELATED APPLICATION

This application claims the benefit of U.S. Provisional Pat. App. Ser. No. 63/686,433 filed Aug. 23, 2024, the contents of which are hereby incorporated by reference.

### TECHNICAL FIELD

This invention pertains to high voltage electrical switchgear and, more specifically, to a vacuum monitored disconnect switch including a vacuum interrupter with a vacuum monitor including a capacitance manometer.

### BACKGROUND

One downside to using vacuum interrupter technology is that the vacuum level inside of the interrupter bottle cannot be measured or maintained. This leads to a reliability and safety concern for utilities that utilize this technology. If the interrupter is called upon to break load when the vacuum level is not adequate, the interrupter bottle will fail. This failure can cause significant damage to utility equipment and can also injure personnel. This also leads to unexpected outages and equipment replacement which have a substantial financial impact. A continuing need therefore exists for more safe and reliable vacuum interrupters.

### SUMMARY

The present invention solves the problem described above through a vacuum monitored disconnect switch connected to an electric power line. The vacuum monitored disconnect switch includes a vacuum interrupter operatively connected to a disconnect switch. The vacuum interrupter includes a vacuum bottle containing an interrupter contactor. A vacuum monitor in fluid communication with the vacuum bottle includes a capacitance manometer for detecting a vacuum failure of the vacuum bottle.

In a representative embodiment, a power supply provides electric power harvested from the electric power line to the vacuum monitor, which is attached to a bottom portion of the vacuum interrupter. In this example, the power supply includes a current transformer inductively coupled to the electric power line. The vacuum monitor includes a porcelain tube in fluid communication with the vacuum bottle of the vacuum interrupter that creates a reference pressure region inside a housing of the vacuum monitor. The porcelain tube also provides voltage isolation between the vacuum bottle and the capacitance manometer. The vacuum interrupter may also include a visual indicator for indicating a failure of the vacuum bottle detected by the vacuum monitor.

It will be understood that specific embodiments may include a variety of features in different combinations, and that all of the features described in this disclosure, or any particular set of features, need not be included in particular embodiments. The specific techniques and structures for implementing particular embodiments of the invention and accomplishing the associated advantages will become apparent from the following detailed description of the embodiments and the appended drawings and claims.

### BRIEF DESCRIPTION OF THE FIGURES

The numerous advantages of the invention may be better understood with reference to the accompanying figures in which:

FIG. 1 is a front view of a monitored disconnect switch for an electric distribution power line.

FIG. 2 is a cross-sectional side view a vacuum interrupter with a vacuum monitor.

FIG. 3 is a side view of the of the monitored disconnect switch.

FIG. 4 is a conceptual cross-sectional illustration of the vacuum monitor.

FIG. 5 is a functional block diagram of a disconnect switch maintenance system utilizing the vacuum monitor.

### DESCRIPTION OF ILLUSTRATIVE EMBODIMENTS

An illustrative embodiment of the invention includes a vacuum monitored disconnect switch that includes a vacuum interrupter with a high-voltage electric contactor inside a vacuum bottle, which can fail causing the vacuum switch to electrically short potentially causing extensive damage to the switch and other components. A vacuum monitor detects failure of the vacuum switch causing the switch to be disabled until it is repaired or replaced. While different types of vacuum monitors may be used, the representative embodiment utilizes a capacitance manometer, which is a commercially available component. The capacitance manometer detects failure of the vacuum bottle by detecting a vacuum failure inside the vacuum monitor, which is in fluid communication with the interrupter vacuum bottle. The capacitance manometer and associated components are powered by a current transformer (CT) that harvests power from the power line controlled by the vacuum disconnect switch. A porcelain tube in fluid communication with the interrupter vacuum bottle provides high voltage isolation between the vacuum interrupter bottle and the capacitance manometer to protect the manometer and associated electronics. The capacitance manometer detects failure of the vacuum bottle by detecting a vacuum failure inside the vacuum monitor, which is in fluid communication with the vacuum bottle.

A vacuum failure signal from the capacitance manometer triggers response actions, such as activating a visual indicator, activating other alarms, disabling the switch until the vacuum interrupter is repaired, and entering a maintenance order. This allows the life of the vacuum interrupter to be significantly increased while simultaneously improving the reliability and safety of operating vacuum interrupters.

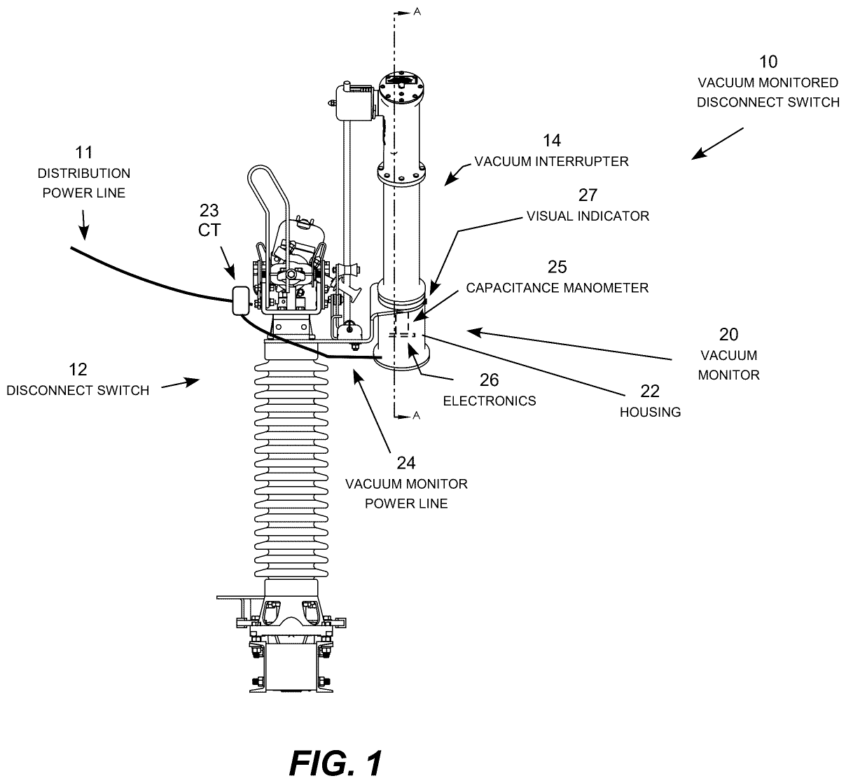

Referring now to illustrative embodiments, FIG. 1 is a front view of a monitored disconnect switch 10 for an electric distribution power line 11 controlled by a disconnect switch 12. The disconnect switch 10 includes a vacuum interrupter 14. This example illustrates a conventional vertical-break disconnect switch, in which the innovation is embodied in a vacuum monitor 20, which is located in a housing 22 attached to a bottom side of the vacuum interrupter 14. The vacuum monitor 20 is powered by a current transformer (CT) 23 that inductively harvests electric power from the power line 11, which is delivered to the vacuum monitor 20 by a vacuum monitor power line 24. The vacuum monitor 20 includes a capacitance monometer 25 and electronics 26 powered by the vacuum monitor power line 24. The vacuum monitor 20 also includes a visual indicator 27, such as an LED, illuminated when the vacuum monitor 20 detects failure of the vacuum bottle in the vacuum interrupter 14.

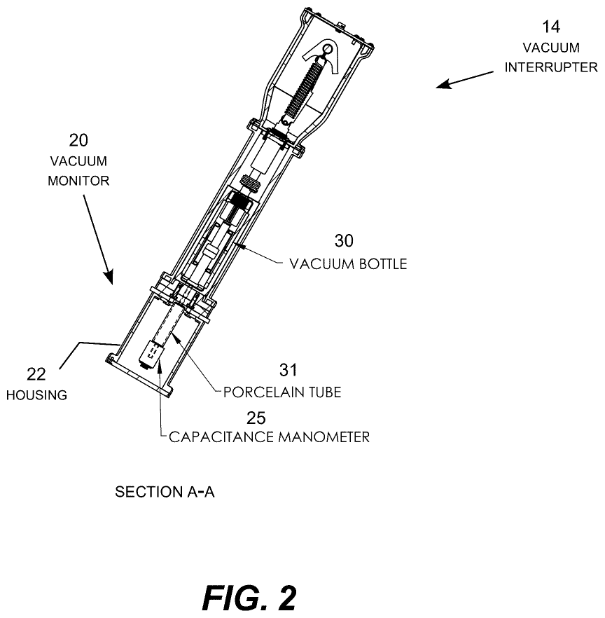

FIG. 2 is a cross-sectional side view the vacuum interrupter 14 and vacuum monitor 20 showing the capacitance manometer 25 inside the housing 22 of the vacuum monitor, which is attached to the bottom of the vacuum interrupter. This view shows the vacuum bottle 30 inside the vacuum interrupter in fluid communication with a porcelain tube 31 electrically isolating the vacuum bottle from the capacitance manometer. In this embodiment, the capacitance manometer 25 and associated controls are located inside the housing 22. The capacitance manometer 25 detects a vacuum failure of the vacuum bottle 30 by detecting a vacuum failure within the housing 22 of the vacuum monitor 22, which is in fluid communication with the vacuum bottle 30.

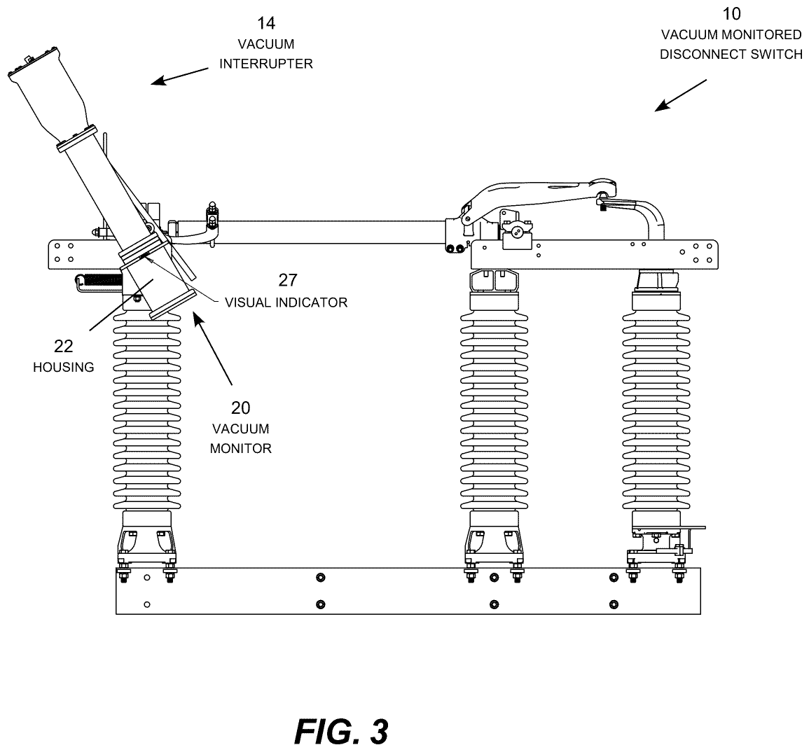

FIG. 3 is a side view of the of the monitored disconnect switch 10. This view shows the visual indicator 10 located on the housing 22 of the vacuum monitor 20.

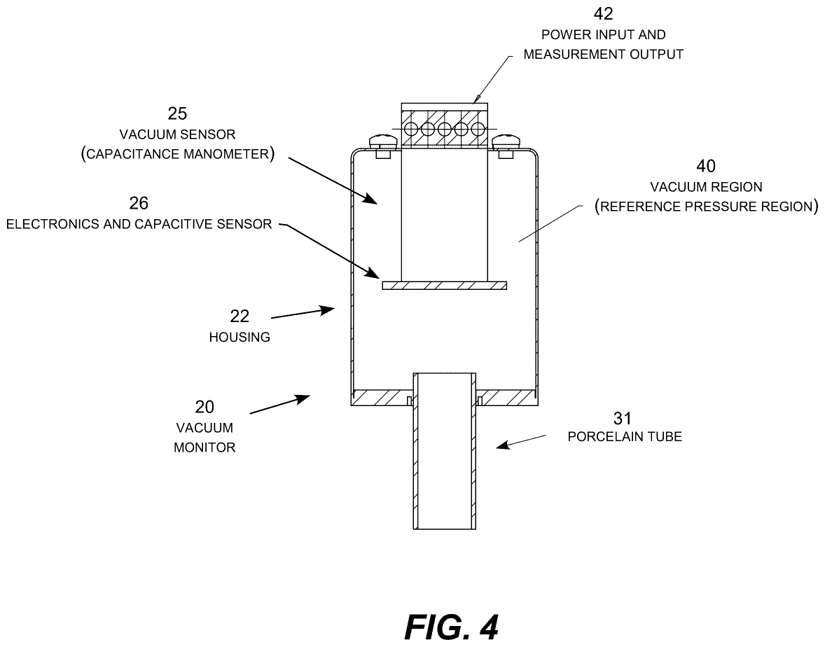

FIG. 4 is a conceptual cross-sectional illustration of the vacuum monitor 20. The porcelain tube 31 is in fluid communication with the vacuum bottle of the vacuum interrupter creating a vacuum region 40 inside the housing 22 in fluid communication with the vacuum bottle of the vacuum interrupter. This provides a reference pressure region 40 inside the housing 22 in fluid communication with the vacuum bottle of the vacuum interrupter. The capacitive manometer 25 detects a vacuum failure of the reference pressure region 40 inside the housing 22, which indicates a vacuum failure of the vacuum bottle of the vacuum interrupter. Power input and measurement output 42 is supplied to the vacuum sensor 25. The electronics and capacitive sensor 26 of the vacuum sensor 25 are positioned in the vacuum region 40, which allows the vacuum sensor 25 to detect a vacuum failure of the vacuum bottle of the vacuum interrupter.

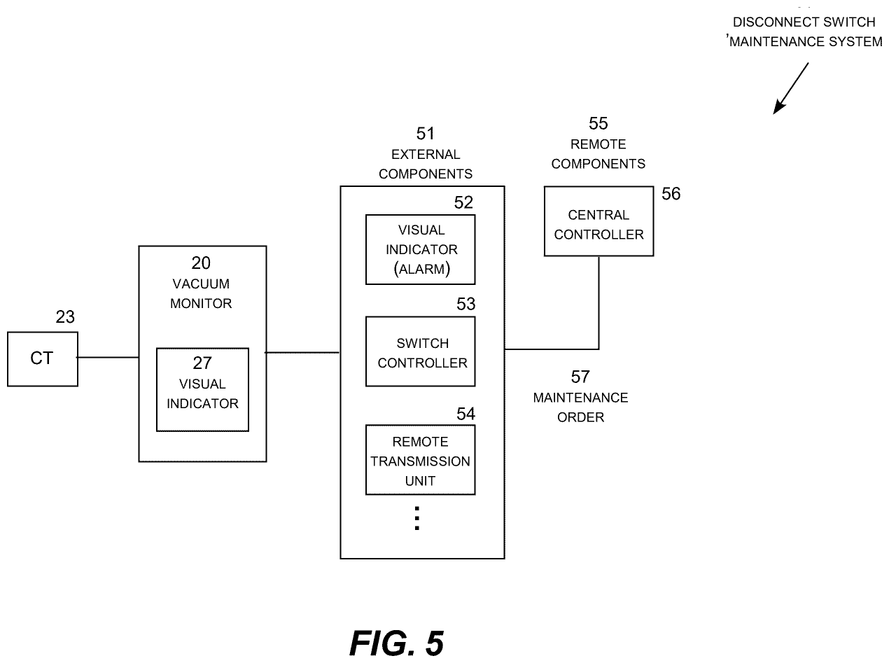

FIG. 5 is a functional block diagram of a disconnect switch maintenance system 50 utilizing the vacuum monitor 20. The CT 23 provides electric power supply to the vacuum monitor 20, which includes a visual monitor 27 located on the monitor housing or another convenient location. A wired or wireless connection communicates information from the vacuum monitor 20 to the external components 20 of the disconnect maintenance system 50. An indication of vacuum failure activates an external visual indicator (alarm) 52 and instructs the switch controller 53 to temporarily disable operation of the disconnect switch 12 until vacuum interrupter is repaired. The remote transmission unit 54 creates a maintenance order 55 for repair of the vacuum interrupter, which is relayed to the central controller 56 for dispatch of a repair crew.

In view of the foregoing, it will be appreciated that present invention provides significant improvements in vacuum disconnect switches. The foregoing relates only to the exemplary embodiments of the present invention, and that numerous changes may be made therein without departing from the spirit and scope of the invention as defined by the following claims.

The invention claimed is:

1. A vacuum monitored disconnect switch connected to an electric power line, comprising:
a disconnect switch;
a vacuum interrupter operatively connected to the disconnect switch comprising a vacuum bottle containing an interrupter contactor;
a vacuum monitor in fluid communication with the vacuum bottle comprising a capacitance manometer for detecting a vacuum failure of the vacuum bottle.

2. The vacuum monitored disconnect switch of claim 1, further comprising a power supply providing electric power harvested from the electric power line to the vacuum monitor.

3. The vacuum monitored disconnect switch of claim 2, wherein the power supply comprises a current transformer inductively coupled to the electric power line.

4. The vacuum monitored disconnect switch of claim 1, wherein the vacuum monitor is attached to a bottom portion of the vacuum interrupter.

5. The vacuum monitored disconnect switch of claim 1, further comprising a porcelain tube in fluid communication with the vacuum bottle creating a vacuum region inside a housing of the vacuum monitor providing a reference pressure region in fluid communication with the vacuum bottle of the vacuum interrupter.

6. The vacuum monitored disconnect switch of claim 5, wherein porcelain tube provides voltage isolation between the vacuum bottle and the capacitance manometer.

7. The vacuum monitored disconnect switch of claim 1, further comprising a visual indicator for indicating a failure of the vacuum bottle detected by the vacuum monitor.

8. A disconnect switch maintenance system, comprising:
a disconnect switch;
a vacuum interrupter operatively connected to the disconnect switch comprising a vacuum bottle containing an interrupter contactor;
a vacuum monitor in fluid communication with the vacuum bottle comprising a capacitance manometer for detecting a vacuum failure of the vacuum bottle;
a switch controller for switch controller for temporarily disabling operation of the disconnect switch in response to the detected vacuum failure of the vacuum bottle.

9. The disconnect switch maintenance system of claim 8, further comprising a central controller for dispatching a repair crew to repair the vacuum interrupter in response to the detected vacuum failure of the vacuum bottle.

10. The disconnect switch maintenance system of claim 9, further comprising a remote transmission unit for transmitting a maintenance order to central controller for dispatching the repair crew to repair the vacuum interrupter.

11. A vacuum interrupter for a vacuum monitored disconnect connected to an electric power line, comprising:
a vacuum interrupter comprising a vacuum bottle containing an interrupter contactor;
a vacuum monitor in fluid communication with the vacuum bottle comprising a capacitance manometer for detecting a vacuum failure of the vacuum bottle.

12. The vacuum interrupter of claim 11, further comprising a power supply providing electric power harvested from the electric power line to the vacuum monitor.

13. The vacuum interrupter of claim 12, wherein the power supply comprises a current transformer inductively coupled to the electric power line.

14. The vacuum interrupter of claim 11, wherein the vacuum monitor is attached to a bottom portion of the vacuum interrupter.

15. The vacuum interrupter of claim 11, further comprising a porcelain tube in fluid communication with the vacuum bottle creating a vacuum region inside a housing of the vacuum monitor providing a reference pressure region in fluid communication with the vacuum bottle of the vacuum interrupter.

16. The vacuum interrupter of claim 15, wherein porcelain tube provides voltage isolation between the vacuum bottle and the capacitance manometer.

17. The vacuum interrupter of claim 11, further comprising a visual indicator for indicating a failure of the vacuum bottle detected by the vacuum monitor.
